(19) United States
(12) Patent Application Publication
(10) Pub. No.: US 2016/0305315 A1
(43) Pub. Date: Oct. 20, 2016

(54) EXTERNAL COOLING FIN FOR ROTARY ENGINE

(71) Applicant: NATIONAL CHUNG_SHAN INSTITUTE OF SCIENCE AND TECHNOLOGY, TAOYUAN CITY (TW)

(72) Inventors: Dun-Zen Jeng, TAOYUAN CITY (TW); Chih-Chuan Lee, TAOYUAN CITY (TW); Chien-Chou Weng, TAOYUAN CITY (TW)

(21) Appl. No.: 15/191,518

(22) Filed: Jun. 23, 2016

Related U.S. Application Data
(63) Continuation-in-part of application No. 14/213,459, filed on Mar. 14, 2014.

(51) Int. Cl. F02B 55/12; F01P 1/02

(52) U.S. Cl. CPC F02B 55/12; F01P 1/02

(57) ABSTRACT

An external cooling fin of a rotary engine is mounted onto the housings of the rotary engine and includes a plurality of cooling teeth for lowering the temperature of the rotary engine, and each cooling fin includes a root and two or more outstretching fin stems, and the root is coupled to the rotary engine housings, so as to achieve a high-efficiency heat dissipation.

### BACKGROUND OF THE INVENTION

1. Field of Invention The present invention relates to a cooling fin, and particularly to an external cooling fin for a rotary engine.

2. Description of Related Art

In general, an engine cooling system is mainly categorized into a water-cooling type and an air-cooling type. The air-cooling type has two alternatives, a natural air cooling and a compulsory air cooling. The compulsory air cooling inducts external cooling air by a device (such as a compressor) on heat dissipation, but the natural air cooling, by natural airflow from the vehicle speed.

The rotary engine is unique in its assembly, which includes side housings, housing outer casings, center housing, an eccentric shaft and a rotor. The triangular-shaped rotor is aligned in the housings and mounted on the eccentric shaft which the rotor revolves on, and air breathing through the ports on the center housing.

Due to fewer components, the rotary engine, with rotational motion in operation, has the advantages of compact size in comparison to a 3-cylinder piston engine, with reciprocating motion in operation, and also it characterizes with light weight, low fuel consumption, and high thrust/load. Therefore, ordinary cooling system with a relative large size on the piston engine may not be compatible with a rotary engine. With high heat load over limited surface area, a light-weighted fin to extend the exposed surface area for the rotary engine heat dissipation is designed.

With reference to FIGS. 6 and 7 for a perspective view of a rotary engine and an external cooling fin according to the Prior Art. As shown in FIG. 6, the rotary engine being shape like concentric circles, the cooling fins being radially mounted around the peripheral of the rotary engine, and the slot of each cooling fins having same width from the central (ignition location) to the housing of the rotary engine. The distances between the lower portions of the respective cooling fins and the ignition location of the of the rotary engine housing are the same, each the cooling fins in a V-shape, such that the number of cooling fins that can be placed in the limited space on the surface of the rotary engine is rather limited. As shown in FIG. 7, the structure of each the cooling fins having a wide slot, the number of cooling fins are few, further, in the limited on heat dissipation efficiency. Therefore, how to increase the number of cooling fins placed in such a limited space to raise heat dissipation efficiency is an urgent task in this field.

### SUMMARY OF THE INVENTION

In view of the shortcomings of the prior art, it is a primary objective of the present invention to overcome the shortcomings by applying an external cooling fin to a rotary engine, wherein a rotary engine has several coupled cooling fins, tuning-forklike, atop the housings and side housings to enhance heat dissipation efficiency.

To achieve the aforementioned objective, the present invention provides both side housings and rotor center housing which has several tuning-forklike fins atop for lowering the temperature of the rotary engine. The cooling fins are coupled and rooted on the housing along with its outer surface. And the roots of the tuning-fork-like fins can be in regular or irregular shape, equal or unequal width. The length ratio of the fins to the roots is approximately 2:1. 2-tooth tuning fork fins or multi-tooth fins are included in the present invention.

The gap between the fins can be coarse or fine based on the heat distribution on the housings. More fine-distributed fins are required for high heat load at combustion zone than the others. As to the cold zone close to the intake port, it is not a must to have fins.

The cooling fins are aligned to the center of the crank shaft and extended radially outward from the roots on the housing outer casings, orthogonal or with a tilt angle from the surface.

The root and the outward stem of the cooling fin can be integrally formed as a whole, wherein the cooling fin has a thickness from 1 mm to 3 mm, and a length from 5 cm to 10 cm, but the invention is not limited to such arrangements only.

The objective of the present invention is to raise heat dissipation efficiency, to achieve the foregoing objective, the cooling fins includes several long slots and several short slots, each the long slots and the short slots being equidistant staggered arrangement to mounted onto the periphery of the rotor engine housing, the long slots and the short slots are formed into an A-shape or a fan-shape having equal distance in between, and to form a structure of the long slots and the short slots of different lengths on the rotary engine. That is to increase the number of the slots put in a limited space on the surface of a rotary engine. Increase the space of cold air fluid and to increase heat dissipation. Base on to arrangement for the long slots and the short slots, the long slot be mounted closer to a chamber of the rotary engine, the short slots be mounted closer to outside of the rotary engine housing, and to in realizing raised heat dissipation. In achieving increased number of the slots on the rotary engine and raised heat dissipation efficiency.

### BRIEF DESCRIPTION OF THE DRAWINGS

FIG. 1A is a front view of a rotary engine and an external cooling fin of the present invention;

FIG. 1B is a perspective view of a rotary engine and an external cooling fin of the present invention;

FIG. 2 is a sectional view of an external cooling fin for a rotary engine of the present invention;

FIG. 3A is a perspective view of a rotary engine in accordance with another embodiment of the present invention;

FIG. 3B is a perspective view of a rotary engine and an external cooling fin according to a first embodiment of FIG. 3A;

FIG. 3C is a perspective view of a rotary engine and an external cooling fin according to a second embodiment of FIG. 3A;

FIG. 4 is a partially enlarged view of the external cooling fin in FIG. 3A;

FIG. 5A is a perspective view of cooling fins of the Prior Art and the present invention;

FIG. 5B shows the temperature contours of heat-flux surface for cooling fins of the Prior Art and the present invention;

FIG. 5C shows the volume-averaged temperatures for cooling fins of the Prior Art and the present invention;

FIG. 6 is a perspective view of a rotary engine and an external cooling fin according to the Prior Art; and

FIG. 7 is a perspective view of a rotary engine and an external cooling fin according to another Prior Art.

### DETAILED DESCRIPTION OF THE INVENTION

The technical characteristics and objectives of the present invention can be further understood by the following detailed description of preferred embodiments and related drawings.

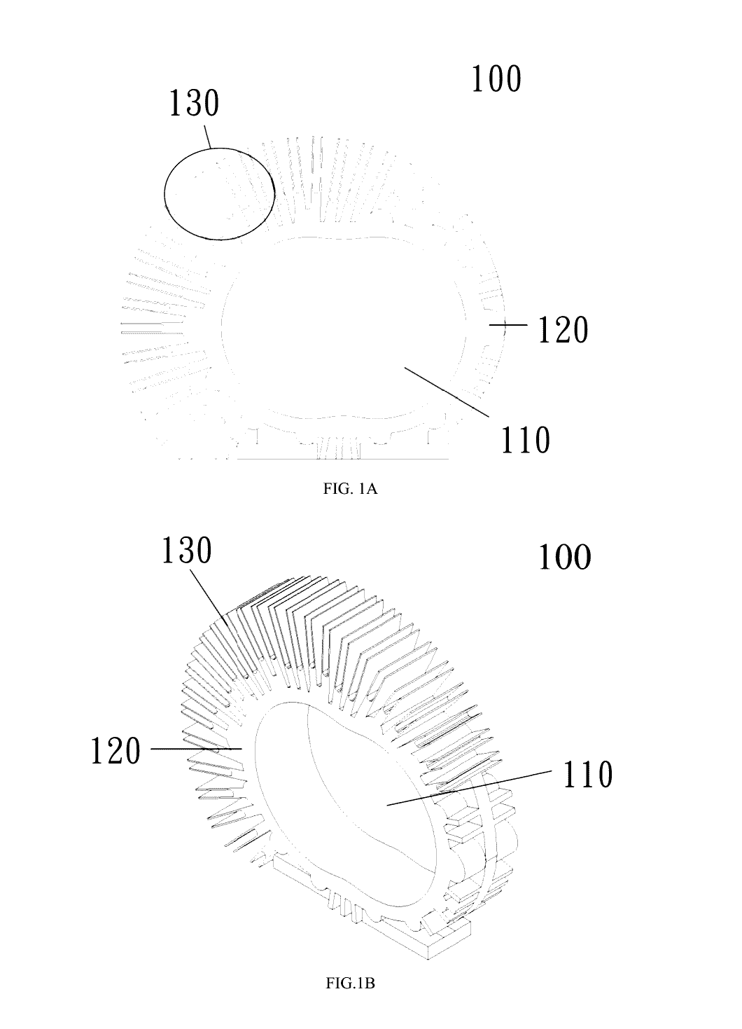

With reference to FIGS. 1A-1B for the front view and the perspective view of a rotary engine and an external cooling fin of the present invention respectively, the rotary engine 100 has a rotor (not shown in the figure) installed in a power chamber 110 of the rotary engine 100 and rotated. When the rotary engine is in operation, a substantial amount of heat is generated, and must be released by a heat dissipation process. In this preferred embodiment, the air cooling system utilizes the plurality of cooling teeth 130, tuning fork like, mounted onto the outer surface of a rotary engine housing 120 to perform the heat dissipation of the rotary engine in order to maintain the small volume and light weight features of the rotary engine. As a part of the rotary engine 100, the cooling teeth can be made of a metal or an alloy, and the heat from the rotary engine can be released through the fins on the rotary engine housing 120 to the air. The cooling effect is dominated by the surface area, therefore the plurality of cooling teeth 130 atop of the rotary engine housings can increase the heat dissipating area to improve the heat dissipation efficiency, wherein the cooling teeth 130 and the rotary engine housing 120 can be integrally formed as a whole or connected to each other as an assembly.

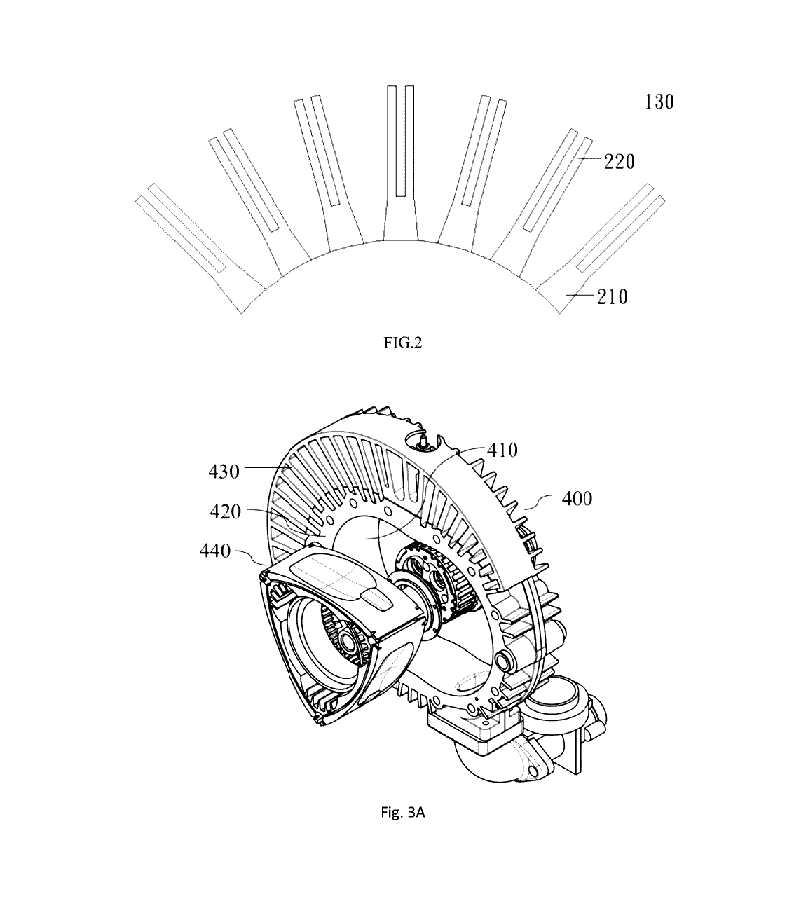

With reference to FIG. 2 for a sectional view of an external cooling fin for a rotary engine in accordance with the present invention, this figure is a sectional view of the cooling fin 130 f FIG. 1.

Each of the coupled cooling teeth 130, tuning fork like, includes a root 210 that stretches outward into two teeth 220, and the root 210 is disposed at the bottom of the cooling fins 130, and coupled to the rotary engine housing 120 The root 210 and the rotary engine housing 120 can be integrally formed as a whole, or connected to each other as an assembly. The heat generated from the combustion of the engine conducts through the root 210 on the housing to the fins 220.

The two-tooth fins 220 enlarge the exposed surface area for dissipating the heat effectively, so that different outward stretching fin teeth such as a three, or a four is included in the present invention. In this preferred embodiment, the two-tooth fin is used to improve the heat dissipation efficiency. The length ratio of the fin tooth 220 to the root 210 will be ranged from 1 to 3.

In this preferred embodiment, the length ratio of the root 210 to the fin tooth 220 is approximately 1:2. In other words, the root length takes one third of the total length, from the bottom of the root to the fin tip. In this preferred embodiment, the thickness of the cooling fin 130 ranges from 1 mm to 10 mm, and the length from 5 cm to 30 cm, but the invention is not limited to such ranges only.

The cooling teeth 130 are radially, to the crank shaft center, stretched outward from the root 210 and distributed circumferentially along the engine housing, so the gap at the bottom of the cooling fin 130 is narrower than that at the tip of the cooling fin 130.

The heat distribution of the rotary engine 100 is not uniform. For instance, higher temperature appears at the ignition location of the rotary engine 100, and lower temperature, around the intake port of the rotary engine 100. If the cooling teeth 130 of the rotary engine 100 are equal spaced on the rotary engine, then the fins at high temperature zone close to ignition location will be insufficient or the fins at low temperature zone close to the intake port will be more than necessary and increase the overall weight. In this preferred embodiment, the cooling teeth 130 are distributed with different densities based on the heat load distribution. Therefore, the cooling fins at high heat zone, between ignition location and the exhaust port, takes high density distribution to offer sufficient exposed surface area for heat dissipation. The cooling fins at the low temperature zone, between the intake port to the ignition location, takes low density distribution or no fins required there in order not to have an excess weight.

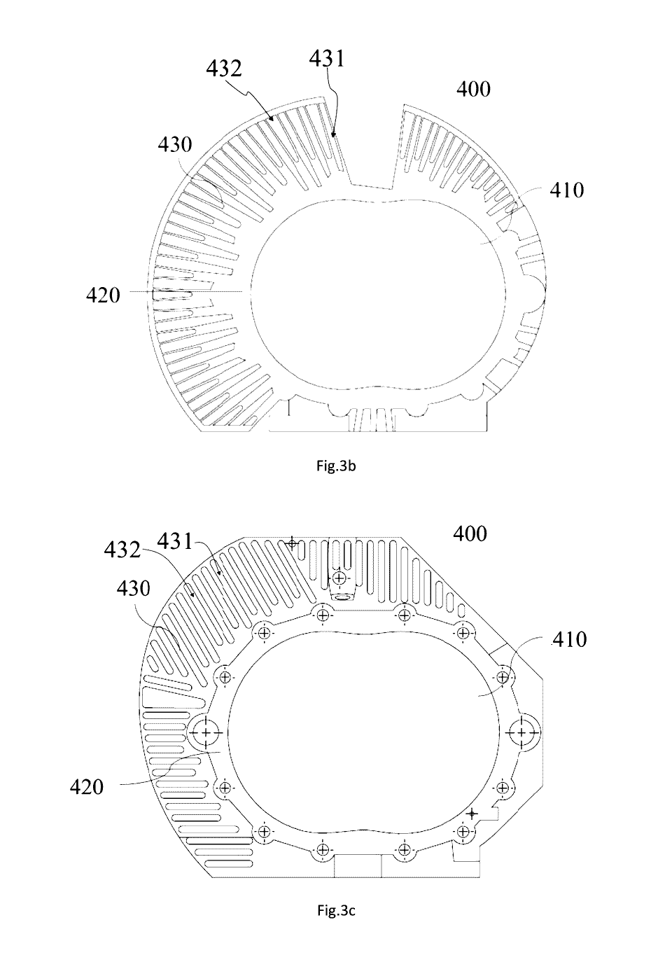

In the following, the major improvements of the present invention over the Prior Art are described in detail, and that is applicable to both the embodiment shown respectively in FIGS. 3A to 3C.

With reference to FIG. 3A for the perspective view of a rotary engine 400 and plurality external of cooling fins 430, the rotary engine 400 has a rotor 440 installed in a chamber 410 of a rotary engine housing 420 of the rotary engine 400 and rotated. When the rotary engine 400 is in operation, a substantial amount of heat is generated, and must be released by a heat dissipation process. As a part of the rotary engine 400, the cooling fins 430 can be made of a metal or an alloy, and the heat from the rotary engine 400 can be released through the cooling fins 430 on the rotary engine housing 420 to the air. The cooling effect is dominated by the surface area, therefore the cooling fins 430 atop of the rotary engine housings 420 in the present invention can effectively increase the surface area to improve the heat dissipation efficiency, wherein the cooling fins 430 and the rotary engine housing 420 can be integrally formed as a whole or connected to each other as an assembly. In this preferred embodiment, the thickness of the cooling fin 430 ranges from 1 mm to 3 mm, and the length from 5 cm to 10 cm, but the invention is not limited to such ranges only. With reference to FIGS. 3B and 3C, the cooling fins 430 includes several long slots 431 and several short slots 432. The long slots 431 and the short slots 432 are a channel for air flow. Each the long slots 431 and the short slots 432 is equidistant staggered arrangement to mounted onto the periphery of the rotor engine housing 420 radially out-stretching having a tilt angle and in parallel, and the long slots 431 and the short slots 432 are formed into an A-shape or a fan-shape having equal distance in between (around the ignition location), to form a structure of the long slots 431 and the short slots 432 of different lengths on the rotary engine 400, while the long slots 431 and the short slots 432 can be arranged as required, to fully utilize the space on the surface of the rotary engine 400, in realizing increased number of the long slots 431 and the short slots 432 placed thereon. In the heat dissipation process, the contact area for the air flow is increased, in achieving raised heat dissipation efficiency.

The heat distribution of the rotary engine 400 is not uniform. For instance, higher temperature appears at the ignition location of the rotary engine 400, and lower temperature, around the intake port of the rotary engine 400. If the cooling fins 430 of the rotary engine 400 are equal spaced on the rotary engine 400, then the cooling fins 430 at high temperature zone close to ignition location will be insufficient or the cooling fins 430 at low temperature zone close to the intake port will be more than necessary and increase the overall weight. In this preferred embodiment, the cooling fins 430 are distributed with different densities based on the heat load distribution. Therefore, the cooling fins 430 at high heat zone, between ignition location and the exhaust port, takes high density distribution to offer sufficient exposed surface area for heat dissipation. The cooling fins 430 at the low temperature zone, between the intake port to the ignition location, takes low density distribution or no fins required there in order not to have an excess weight as shown in FIGS. 3B and 3C.

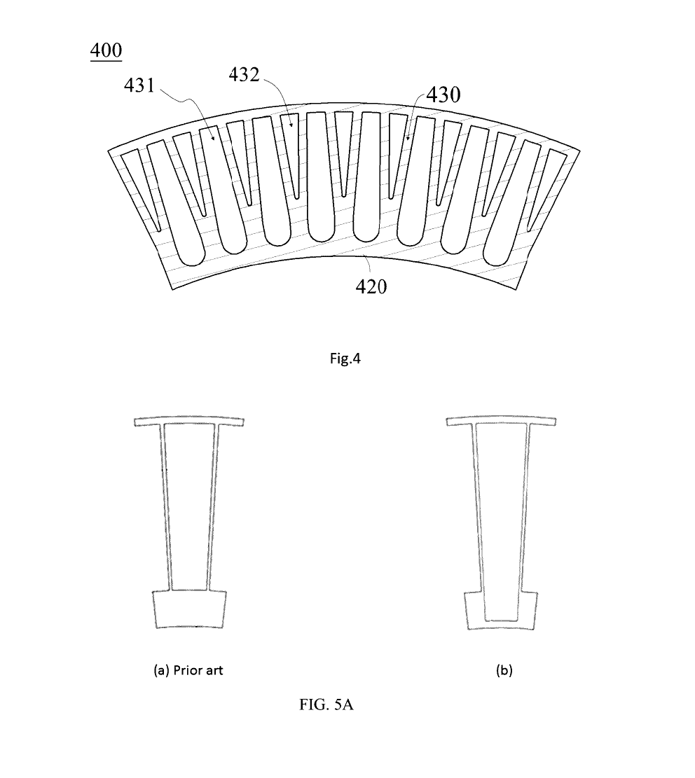

With reference FIG. 4, the long slots 431 and the short slots 432 mounted on the rotary engine 400, the lengths of the long slots 431 and the short slots 432 can be varied, structure of bottom of the long slots 431 is mounted closer to core of the rotary engine 400, and to in realizing raised heat dissipation. The short slots 432 is equidistant mounted between each of the long slots 431, and is mounted closer to outside of the rotary engine housing 420. The short slots 432 to fill in space on the surface in each the long slots 431. That is to increase the number of the slots put in a limited space on the surface of a rotary engine 400. Increase the space of cold air fluid and to increase heat dissipation.

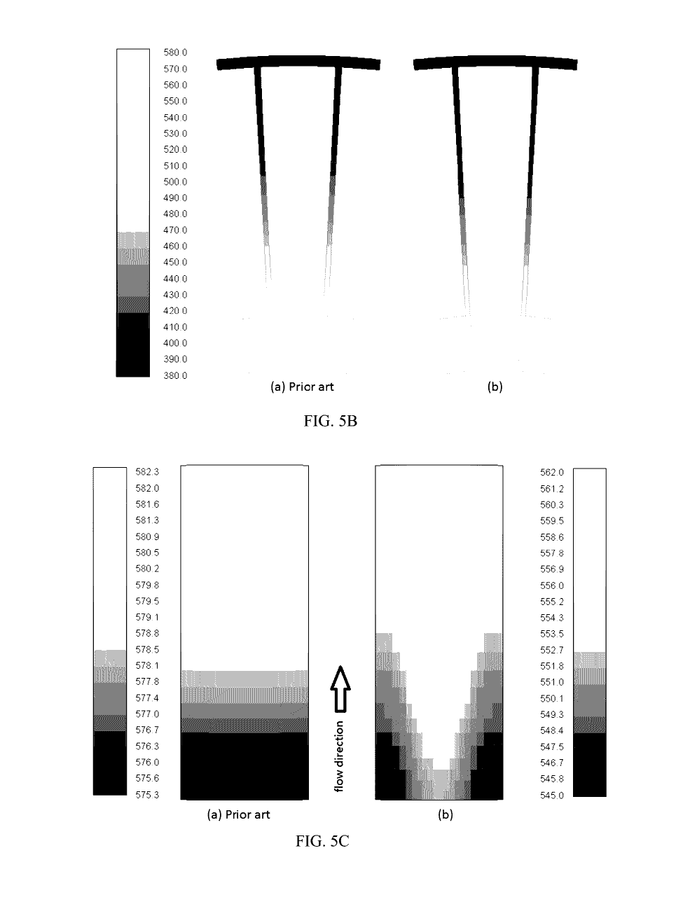

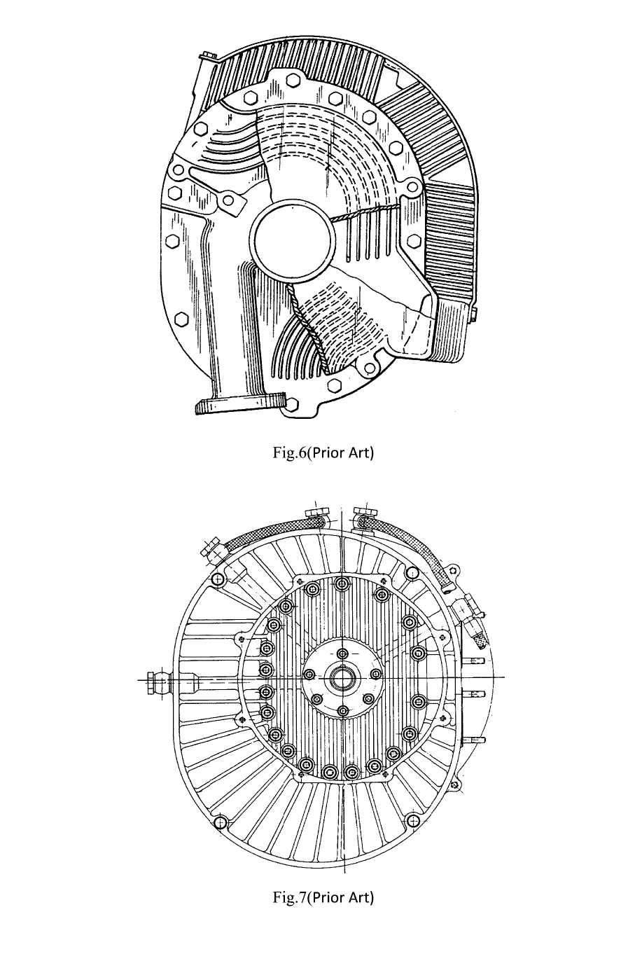

Refer to FIG. 5A for a perspective view of cooling fins and slots of the Prior Art and the present invention. On the left hand part (a) of the drawing is the case referred to the Prior Art, while on the right hand part (b) of the drawing is the case referred to the present invention. On the left hand part (a) bottom of the Prior Art having same thickness of each cooling fins and same lengths of each slots. On the right hand part (b) the lengths of the cooling fins and slots can be designed to be varied, to form a structure of the slots of different lengths, while the cooling fins can be arranged as required, to fully utilize the space on the surface of the rotary engine, in realizing increased number of the slots placed thereon. In the heat dissipation process, the contact area for the air flow is increased, in achieving raised heat dissipation efficiency.

Refer to FIGS. 5B, and 5C respectively for the temperature contours of heat-flux surface for cooling fins of the Prior Art and the present invention; and the volume-averaged temperatures for cooling fins of the Prior Art and the present invention. On the left hand parts (a) of the drawings are the cases referred to the Prior Art, while on the right hand parts (b) of the drawings are the cases referred to the present invention. Compared with the Prior Art, the surface temperature of the cooling fins of the present invention can be reduced significantly, and that indicates that the rotary engine is able to achieve better heat dissipation. In the present invention, the volume-averaged temperature of fin model is 468.4K, while in the Prior Art, the temperature is 504.9K. That means, in the present invention, the surface temperature of the cooling fin can be lowered more than 10K than that of the Prior Art, so that lifespan of the cooling fins of the present invention can be doubled. In conclusion, the bottoms of the slots of the present invention can be indented so that structure of the slots may have different lengths, hereby raising the heat dissipation efficiency of the present invention, while increasing the cooling fins lifespan. The specific cooling fins in the present invention offer a high air cooling efficiency by increasing the exposed surface area. With its simplicity in function and no other auxiliary devices required, the cooling fins of the present invention effectively fit to a compact engine compartment such as a light sport aircraft. To enhance heat dissipation efficiency, continuous fin design and testing are required in sizes, shapes, and density alignments to secure a stable rotary engine operation. The external cooling fins in the present invention are typically used in a rotary engine to achieve a better heat dissipation efficiency for a more stable engine operation.

While the invention has been described by means of specific embodiments, numerous modifications and variations could be made thereto by those skilled in the art without departing from the scope and spirit of the invention set forth in the claims.

What is claimed is:

1. An external cooling fin of a rotary engine, installed on a rotary engine housing of the rotary engine, comprising: a rotor installed in a chamber, and plurality of cooling fins, for dissipating heat and reducing temperature of the rotary engine; wherein, the cooling fins includes several long slots and several short slots, each the long slots and the short slots being equidistant staggered arrangement to mounted onto the periphery of the rotor engine housing radially out-stretching having a tilt angle and in parallel, the short slots being mounted between each the long slots, the long slots and the short slots being formed into an A-shape or a fan-shape, structure of the long slots and the short slots of different lengths on the rotary engine, the lengths of the long slots and the short slots can be varied, structure of bottom of the long slots being mounted closer to core of the rotary engine, the short slots being mounted closer to outside of the rotary engine housing, being to increase the number of the slots put in a limited space on the surface of a rotary engine, and to in realizing raised heat dissipation, while a depth of the bottom of the cooling fins root and that of two sides of the cooling fins root are different, in achieving increased number of the slots on the rotary engine and raised heat dissipation efficiency.

2. The external cooling fin of a rotary engine according to claim 1, wherein the cooling fin are distributed with different density alignments.

3. The external cooling fin of a rotary engine according to claim 2, wherein the cooling fin are high-density distributed at high heat-load zone from ignition location to exhaust port location.

4. The external cooling fin of a rotary engine according to claim 1, wherein the root and the cooling fin are integrally formed as a whole.

5. The external cooling fin of a rotary engine according to claim 1, wherein the cooling fin has a thickness from 1 mm to 10 mm, and a length from 5 cm to 30 cm.

6. The external cooling fin of a rotary engine according to claim 1, wherein the cold zone of the rotary engine, close to the intake port, may have no cooling fin installed thereon.
